(19) United States
(12) Patent Application Publication
(10) Pub. No.: US 2012/0309247 A1
(43) Pub. Date: Dec. 6, 2012

(54) METHOD FOR THE PRODUCTION OF A HYBRID PART, AND COVER FOR USE IN THE PRODUCTION

(75) Inventors: Markus Kleine, Erwitte (DE); Stefan Willeit, Werther/Westfalen (DE); Waldemar Dinius, Paderborn (DE); Otto Buschsieweke, Paderborn (DE); Konstantin Herlach, Paderborn (DE); Bernd Wohletz, Meitingen (DE); Andreas Steinle, Holzheim (DE)

(73) Assignees: Benteler SGL GmbH & Co. KG, Paderborn (DE); Benteler Automobiltechnik GmbH, Paderborn (DE)

(21) Appl. No.: 13/482,404

(22) Filed: May 29, 2012

(30) Foreign Application Priority Data
May 30, 2011 (DE) 10 2011 050 701.9

(51) Int. Cl. D04H 1/00; B32B 37/00; B32B 38/04; D04H 1/4226

(52) U.S. Cl. 442/327; 156/60; 156/250

(57) ABSTRACT

In a method of making a hybrid part, a reinforcement element of fiber composite is placed upon a base member in a press tool. A strip-shaped cover having a resin absorbing absorbent layer is withdrawn from a supply unit and placed in the press tool between the reinforcement element and the press tool. As the base member and the reinforcement element are compressed with one another and joined any resin issuing out from the reinforcement element is absorbed by the absorbent layer of the cover and kept away from soiling the press tool or the base member. After the compression process, the cover is removed.

### CROSS-REFERENCES TO RELATED APPLICATIONS

This application claims the priority of German Patent Application, Ser. No. 10 2011 050 701.9, filed May 30, 2011, pursuant to 35 U.S.C. 119(a)-(d), the content of which is incorporated herein by reference in its entirety as if fully set forth herein.

### BACKGROUND OF THE INVENTION

The present invention relates to a method for the production of a hybrid part, and cover for use in the production.

The following discussion of related art is provided to assist the reader in understanding the advantages of the invention, and is not to be construed as an admission that this related art is prior art to this invention.

Modern motor vehicle components should be little weight while still exhibiting defined strength properties. Automobile manufacturers strive therefore to produce structural parts that are as lightweight as possible so that a low motor vehicle weight can contribute to a reduction in fuel consumption and CO₂ emission. At the same time, the properties of the structural part, like e.g. strength, stiffness, service life, should not be adversely affected. In fact, those properties should be enhanced while still striving for a reduced weight.

In general, hybrid parts are produced by positioning one or more reinforcement elements in the form of so-called prepregs in or on a base member, and subsequently compressing both components in a press tool. The matrix resin of the prepreg assumes hereby the connection or bonding between fiber composite of the reinforcement element and base member to thereby eliminate the need for an additional joining operation. The resin issuing out of the prepreg poses however a problem during the compression stage because the resin has a very low viscosity at the process-related temperatures of about 160° C. As a result, escaping or excess resin disperses easily and migrates even into smallest gaps so that the press tool and the structural part are wetted with resin. This is undesired because the structural part has to undergo an additional cleaning step, and frequent maintenance work of the press tool is required.

The use of rubber seals or specially designed to provide sealing action has been proposed to prevent unwanted contamination. These proposals suffer however shortcomings. In the case of rubber seals, escaping aggressive resin causes corrosion of the rubber material of the rubber seals which thus age prematurely. Moreover, these rubber seals have to be installed by an additional operating step and subsequently removed again, thereby complicating the overall process. In the case of special tool designs, the production process is complicated and is still inadequate to provide a complete sealing because of the creeping capability of the resin.

It would therefore be desirable and advantageous to address these problems and to obviate other prior art shortcomings.

### SUMMARY OF THE INVENTION

According to one aspect of the present invention, a method of making a hybrid part includes placing a reinforcement element of fiber composite upon a base member in a press tool, withdrawing from a supply unit a strip-shaped cover having a resin absorbing absorbent layer, placing the cover in the press tool between the reinforcement element and the press tool, compressing the base member and the reinforcement element with one another to join them, wherein any resin issuing out from the reinforcement element is absorbed by the absorbent layer of the cover during the compressing step, and removing the cover.

The incorporation of the cover during the compression step between the press tool or those parts of the press tool that act on the reinforcement element and the base member prevents a contact between the press tool and at least the reinforcement element. The resin-absorbing absorbent layer of the cover is able to absorb excess resin which escapes the reinforcement element during compression to thereby prevent the resin from dispersing and spreading to neighboring surfaces of the base member. Once compression is concluded, the cover can easily be removed.

The present invention thus provides a simple approach to prevent the adverse effect of a contamination of the base member or hybrid part with resin. The base member can thus be kept free from resin at least in defined regions thereof so that the quality of the hybrid part is enhanced.

According to another advantageous feature of the present invention, the cover can be made of plural layers. Advantageously, the absorbent layer of the cover can be made from a non-woven material, such as fiberglass fleece. The non-woven is bounded on its outer flat sides by an outer skin which prevents the cover and the absorbent layer from sticking to the reinforcement element or press tool.

According to another advantageous feature of the present invention, the outer skin is formed by a non-adhesive film.

The cover fulfills two tasks when closing the press tool. During compression, the outer skin of the cover in proximal relation to the reinforcement element can be perforated. Small holes and fissures are provided in the outer skin adjacent to the reinforcement element to enable a transfer of low-viscosity resin into the absorbent layer which absorbs the low-viscosity resin by capillary forces. As a result, excess resin is effectively removed.

According to another advantageous feature of the present invention, the cover can be compressed in the marginal areas of the cover, especially in horizontal sections of the base member, to such an extent that no absorbing effect is established. The marginal areas of the cover are held shut in a resin-tight manner during the compressing step. As a result, the press tool is sealed in the corresponding regions so that resin is unable to creep over the formed barrier and to soil the structural parts.

The provision of the cover has the additional benefit of providing tolerance compensation between the base member or a hybrid part to be produced and the press tool.

According to another advantageous feature of the present invention, the cover can be sized to extend completely over the base member and the reinforcement element positioned thereon and then to close the press tool. The cover may have the shape of a strip which can be reeled off a supply device in the form of a roll and placed upon the base member with the reinforcement element positioned thereon. This is followed by the compression step. Thereafter, the cover is wound again on the other side, i.e. removed from the hybrid part and rolled onto a storage unit.

The cover is positioned in such a way as to be able to reliably meet the task at hand during compression and to absorb excess resin that escapes. Suitable, the entire amount of escaping resin is picked up so as to substantially eliminate any contamination of the press tool and the base member. In particular, it is possible to keep defined regions of the base member of the hybrid part free of resin. This is desired especially for subsequent operations, such as for example welding processes.

According to another advantageous feature of the present invention, the compressing step can be executed while the press tool is heated. By heating the press tool, the matrix resin can be influenced to more easily flow and the fiber composite can be cured as a result of the heat impact. As a result, strength of the produced hybrid part can be enhanced. At the same time, the cycle time of the production process can be reduced by the accelerated curing reaction.

According to another aspect of the present invention, a cover for placement between a press tool and a reinforcement element on a base member in the production of a hybrid part includes a resin-absorbing absorbent layer made from a non-woven material. Advantageously, the non-woven material may be a fiberglass fleece. Currently preferred is the use of an absorbent layer having fine pores in which resin can be drawn in by capillary forces. Due to a loose structure of the absorbent layer, fine capillaries are formed which are able to absorb resin. In this way, any resin that may migrate out as the reinforcement element is joined with the base member is absorbed by the absorbent layer.

According to another advantageous feature of the present invention, the cover can have plural layers. Advantageously, the cover can have two outer skins, with the absorbent layer being sandwiched between the outer skins. Suitably, at least one outer skin can be made of non-sticky film. In this way, the need for providing a separating agent between the reinforcement element and a punch of the press tool is eliminated.

According to another advantageous feature of the present invention, the base member can be made of a metallic material, e.g. steel material. Currently preferred is the use of high-strength steel.

The reinforcement element may, for example, be a prepreg material, in particular a calendered laminate of various prepreg layers having different orientation. The prepreg layers may be flat initially and then pressed into or onto the metallic base member during compression.

The cover can be sized to suit at least the reinforcement element being covered. The cover shields the outer contours of the reinforcement element. In principle, the entire surface area of the base member, which is acted upon by the punch of the press tool and has the reinforcement element placed thereon, can be covered by the cover.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a representation of a hybrid part made in accordance with the present invention and configured in the form of a B pillar for a motor vehicle; and

FIGS. 2-6 show sectional views of five operating steps for the production of a hybrid part in a press tool.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

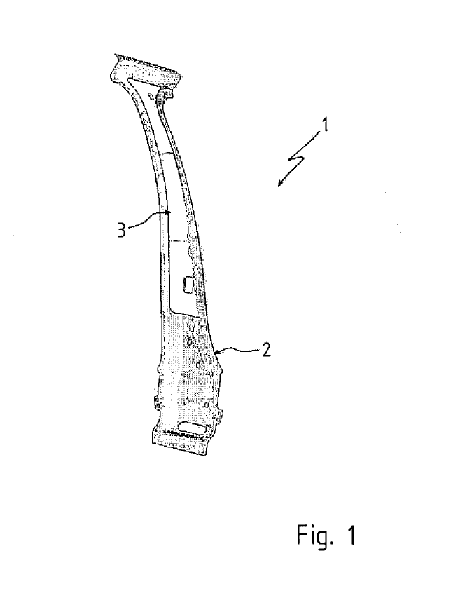

Turning now to the drawing, and in particular to FIG. 1, there is shown a representation of a hybrid part, generally designated by reference numeral 1 and made in accordance with the present invention for use a B pillar for a motor vehicle for example. The hybrid part 1 includes over a major part of its length a cup-shaped base member 2 which is made of steel sheet. The base member 2 is strengthened in part by a reinforcement element 3 made of a fiber composite. The reinforcement element 3 is shaped to conform to the cup shape of the base member 2 and extends in the drawing plane approximately from midsection of the base member 2 upwards to the head zone of the base member 2.

The reinforcement element 3 is formed from a layer of a prepreg of pre-impregnated fibers. Involved here is a semi-finished product comprised of endless fibers and an uncured thermoset plastic matrix. The base member 2 and the reinforcement element 3 are compressed with one another in hot state in a heat press tool 4.

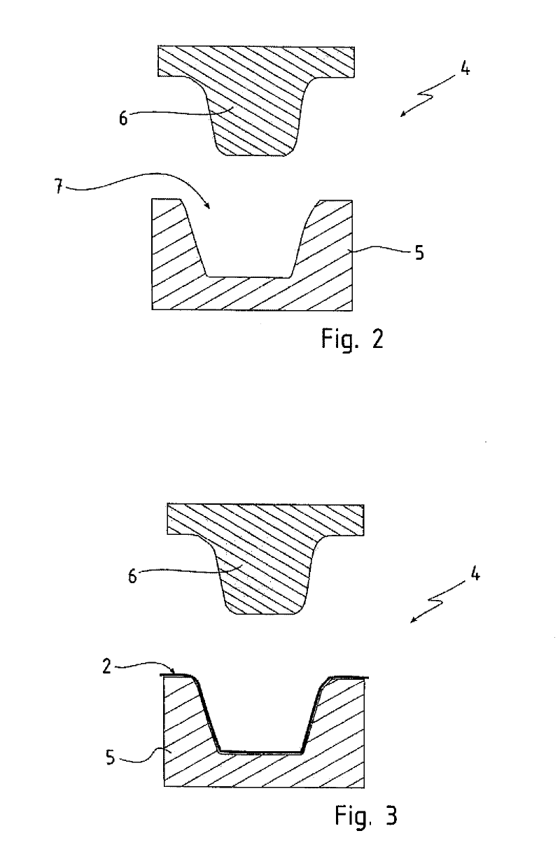

FIG. 2 shows schematically an open press tool 4 having a lower die 5 (female mold) and an upper die 6 (male mold or punch).

The hybrid part 1 is produced by placing the base member 2 of steel sheet into the mold cavity 7 of the lower die 5, as shown in FIG. 3. Thereafter, the reinforcement element 3 is placed upon the base member 2 and positioned. This is shown in FIG. 4.

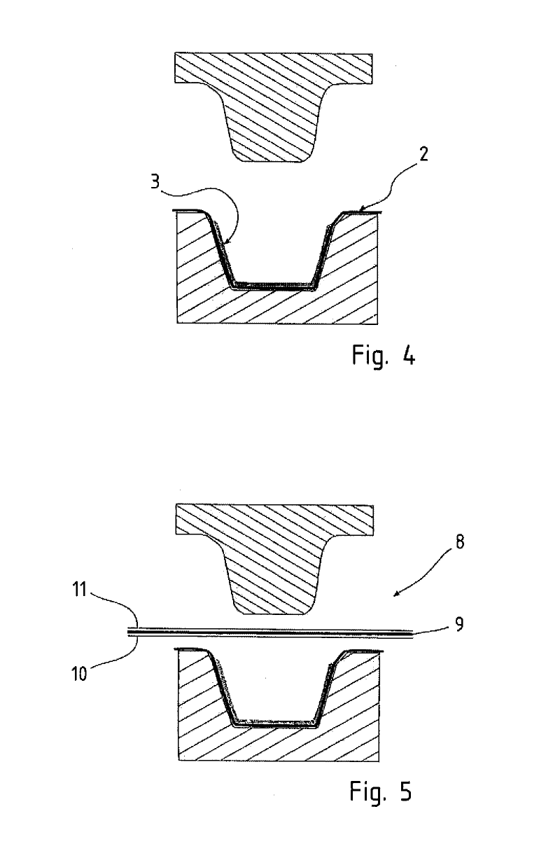

A cover 8 is placed between the reinforcement element 3 and the press tool 4, as shown in FIG. 5. The cover 8 is made of several layers and includes a resin-absorbing absorbent layer 9 which is covered on the top side and the bottom side by outer skins 10, 11, respectively. The absorbent layer 9 is made from resin-absorbing material, such as fine-pore material in which resin can be drawn in by capillary forces. Such a fine-pore absorbent layer 9 can be made of non-woven material, e.g. fiberglass fleece with resin-absorbing properties. The outer skins 10, 11 can be a film, such as a non-sticky film.

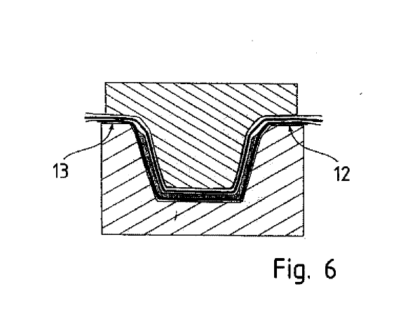

FIG. 6 shows the compression process. The press tool 4 is closed by lowering the upper die 6 into the mold cavity 7 of the lower die 5. The base member 2 and reinforcement element 3 are joined together by pressure and heat. During compression, the outer skin 10 in confronting relation to the reinforcement element 3 is perforated. As a result, the outer skin 10 adjacent the reinforcement element 3 is formed with small holes and fissures through which low-viscosity resin is able to move into the absorbent layer 9 which absorbs the resin by way of capillary forces. In this way, excess resin that issues out of the reinforcement element 3 is picked up during compression and kept away from the base member 2 and the press tool 4, and in particular from the contact zones and pressure surfaces of the upper die 6. The adverse effect of any contamination caused by resin is thus essentially eliminated. The cover 8 is removed after the compression process.

During compression, the cover 8 is greatly compressed in the upper horizontal portions of the upper die 6 so as to eliminate any absorbent effect. As a result, the respective marginal regions 12, 13 of the cover 8 are kept shut in a resin-tight manner during compression to establish a seal that prevents resin from escaping and potentially soiling the press tool 4 or the base member 2.

Currently preferred is the presence of a cover 8 in strip shape which can be reeled off a supply unit and placed upon the base member 2 with the reinforcement element 3 positioned thereon. After the compression process, the cover 8 can be rolled up or wound on the other side onto a storage unit.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of making a hybrid part, comprising:
placing a reinforcement element of fiber composite upon a base member in a press tool;
withdrawing from a supply unit a strip-shaped cover having a resin-absorbing absorbent layer;
placing the cover in the press tool between the reinforcement element and the press tool;
compressing the base member and the reinforcement element with one another to join them, wherein any resin issuing out from the reinforcement element is absorbed by the absorbent layer of the cover during the compressing step; and
removing the cover.

2. The method of claim 1 for making a hybrid part for use in a motor vehicle.

3. The method of claim 1, wherein the base member is made of metal.

4. The method of claim 1, further comprising rolling up the cover onto a storage unit.

5. The method of claim 1, wherein the cover has plural layers.

6. The method of claim 1, wherein the cover has an outer skin in proximal relationship to the reinforcement element, and further comprising perforating the outer skin during the compressing step.

7. The method of claim 1, further comprising keeping marginal areas of the cover shut in a resin-tight manner during the compressing step.

8. The method of claim 1, wherein the compressing step is executed while the press tool is heated.

9. A cover for placement between a press tool and a reinforcement element on a base member in the production of a hybrid part, said cover comprising a resin-absorbing absorbent layer made from a non-woven material.

10. The cover of claim 9, wherein the non-woven material is non-woven material is a fiberglass fleece.

11. The cover of claim 9, wherein the cover has plural layers.

12. The cover of claim 9, further comprising two outer skins, with the absorbent layer being sandwiched between the outer skins.

13. The cover of claim 12, wherein at least one of the outer skins is a film.

14. The cover of claim 12, wherein the film is non-sticky.
